(19) United States
(12) Patent Application Publication
(10) Pub. No.: US 2018/0315092 A1
(43) Pub. Date: Nov. 1, 2018

(54) Server For Providing Internet Content and Computer-Readable Recording Medium Including Implemented Internet Content Providing Method

(71) Applicant: A1 Media Group Co., Ltd., Tokyo (JP)

(72) Inventor: Jae Woo CHUNG, Rochester, NY (US)

(21) Appl. No.: 15/769,852

(22) PCT Filed: Oct. 27, 2016
(86) PCT No.: PCT/KR2016/012176

§ 371 Date: Apr. 20, 2018

(30) Foreign Application Priority Data
Oct. 27, 2015 (KR) 10-2015-0149664

(51) Int. Cl. G06Q 30/02; G06F 17/30

(52) U.S. Cl. CPC G06Q 30/0263; G06F 17/30864; G06Q 30/0277

(57) ABSTRACT

The present invention relates to an Internet content providing server and a computer-readable recording medium in which an Internet content providing method is implemented. The internet content providing server according to an exemplary embodiment of the present invention extracts an interest keyword by collecting and analyzing an action of a user of an Internet content and applies a weighted value based on an action of the user to the extracted interest keyword, and provides an Internet content having a high degree of interest of the user.

### TECHNICAL FIELD

The present invention relates to an Internet content providing server and a computer-readable recording medium in which an Internet content providing method is implemented, and more particularly, to a server, which provides an Internet content corresponding to an interesting keyboard extracted by collecting and analyzing an action of a content user and a content corresponding to the action, and a computer-readable recording medium in which an Internet content providing method is implemented.

### BACKGROUND ART

Internet business operators producing Internet contents wish to know the kinds of contents which Internet users accessing the contents provided by themselves and interested, and the kinds of form and the kind of path which the Internet users distribute contents of interest on the Internet.

The Internet business operator may recognize tendencies of users and a recent trend by analyzing big data of contents of interest of the Internet users and the kind of content distribution and utilize the recognized tendencies of the users and the recent trend in various fields. Particularly, it is possible to provide Internet users with customized contents, such as advertisements and articles, appropriate to each field of interest, or provide a product or service producer with market analysis data for establishing a marketing strategy.

Accordingly, importance for a technology that collects and analyzes action information about an Internet content user and provides a user with a customized content has been emphasized.

### DISCLOSURE

### Technical Problem

The present invention has been made in an effort to provide a server for providing an Internet contents with a high degree of interest of a user according to an interest keyword extracted by collecting and analyzing an action of an Internet content user, and a computer-readable recording medium in which an Internet content providing method is implemented.

The present invention has also been made in an effort to provide a server for applying a weighted value based on an action of a user to an internet keyword of the user, and ranking and providing Internet contents, and a computer-readable recording medium in which an Internet content providing method is implemented.

The exemplary embodiment of the present invention may be used for achieving other objects that are not particularly mentioned, in addition to the foregoing object.

### Technical Solution

An exemplary embodiment of the present invention provides a server for providing an Internet content, the server including: a log collecting unit which collects content information included in a plurality of web pages based on an action of a first user for the plurality of web pages; a first keyword extracting unit which maps the collected content information to a pre-stored commerce dictionary and tokenizes and stores a plurality of commerce keywords among the collected content information; a second keyword extracting unit which maps the collected content information to a pre-stored general dictionary and tokenizes and stores a plurality of general keywords among the collected content information; a weighted value applying unit which applies a first weighted value to a first commerce keyword among the plurality of commerce keywords and applies a second weighted value to a first general keyword among the plurality of general keywords; and a content providing unit which extracts an advertisement content corresponding to the first commerce keyword to which the first weighted value is applied and transmits the extracted advertisement content to a terminal of the first user, and extracts an information content corresponding to the first general keyword to which the second weighted value is applied and transmits the extracted information content to the terminal of the first user.

The weighted value applying unit may apply the first weighted value for the action of the first user corresponding to the first commerce keyword and apply the second weighted value for the action of the first user corresponding to the first general keyword.

The first weighted value may include a weighted value of a group including the first commerce keyword in the commerce dictionary, a weighted value for the number of times of exposure of the first commerce keyword, and a weighted value for the action of the first user corresponding to the first commerce keyword, and the second weighted value may include a weighted value of a group including the first general keyword in the general dictionary, a weighted value for the number of times of exposure of the first general keyword, and a weighted value for the action of the first user corresponding to the first general keyword.

The weighted value applying unit may rank the plurality of commerce keywords and the plurality of general keywords according to a result of the application of the weighted value, and the content providing unit may extract an advertisement content corresponding to the plurality of ranked commerce keywords and transmit the extracted advertisement content to the terminal of the first user, and extract an information content corresponding to the plurality of ranked general keywords and transmit the extracted information content to the terminal of the first user.

The weighted value applying unit may combine and rank the plurality of commerce keywords and the plurality of general keywords according to a result of the application of the weighted value, and the content providing unit may extract an advertisement content and the information content corresponding to a result of the ranking and transmit the extracted advertisement content and information content to the terminal of the first user.

The server may further include: a tag inserting unit which inserts a linkback tag collecting the action of the first user for the plurality of web pages and content information corresponding to the action of the first user; and a content providing unit which transmits the plurality of web pages into which the linkback tag is inserted to the terminal of the first user.

The server may further include: a more-view link generating unit which extracts uniform resource locator (URL) information about a first web page based on a copy action of the first user for a content included in the first web page among the plurality of web pages and a paste action of the first user to a second web page among the plurality of web pages, and generates a more-view link.

Another exemplary embodiment of the present invention provides a server for providing an Internet content, the server including: a content providing unit which transmits a plurality of web pages including different Internet contents to a terminal of a first user; a tag inserting unit which inserts a linkback tag collecting an action of the first user for the plurality of web pages and content information corresponding to the action of the first user; a more-view link generating unit which extracts uniform resource locator (URL) information about a first web page based on a copy action of the first user for a content included in the first web page among the plurality of web pages and a paste action of the first user to a second web page among the plurality of web pages, and generates a more-view link; and a log collecting unit which collects content information included in the first web page and the second web page based on an action of a second user for the first web page and the second web page.

The server may further include: a first keyword extracting unit which maps the collected content information to a pre-stored commerce dictionary and tokenizes and stores a plurality of commerce keywords among the collected content information; and a second keyword extracting unit which maps the collected content information to a pre-stored general dictionary and tokenizes and stores a plurality of general keywords among the collected content information, and the content providing unit may extract an advertisement content corresponding to the plurality of commerce keywords and transmit the extracted advertisement content to the terminal of the second user, and extract an information content corresponding to the plurality of general keywords and transmit the extracted information content to the terminal of the second user.

Still another exemplary embodiment of the present invention provides a computer-readable recording medium in which a program for executing a method of providing an Internet content by using an Internet content providing server is recorded, the method including: a function of collecting content information included in a plurality of web pages based on an action of a first user for the plurality of web pages; a function of mapping the collected content information to a pre-stored commerce dictionary and tokenizing and storing a plurality of commerce keywords among the collected content information; a function of mapping the collected content information to a pre-stored general dictionary and tokenizing and storing a plurality of general keywords among the collected content information; a function of applying a first weighted value to a first commerce keyword among the plurality of commerce keywords; a function of applying a second weighted value to a first general keyword among the plurality of general keywords; a function of extracting an advertisement content corresponding to the first commerce keyword to which the first weighted value is applied and transmitting the extracted advertisement content to the terminal of the first user; and a function of extracting an information content corresponding to the first general keyword to which the second weighted value is applied and transmitting the extracted information content to the terminal of the first user.

The function of applying the first weighted value may include applying a weighted value for the action of the first user corresponding to the first commerce keyword, and the function of applying the second weighted value may include applying a weighted value for the action of the first user corresponding to the first general keyword.

The function of applying the first weighted value may include applying a weighted value of a group including the first commerce keyword in the commerce dictionary, a weighted value for the number of times of exposure of the first commerce keyword, and a weighted value for the action of the first user corresponding to the first commerce keyword, and the function of applying the second weighted value may include applying a weighted value of a group including the first general keyword in the general dictionary, a weighted value for the number of times of exposure of the first general keyword, and a weighted value for the action of the first user corresponding to the first general keyword.

The program may include a function of ranking the plurality of commerce keywords based on a result of the application of the weighted value, a function of extracting an advertisement content corresponding to the plurality of ranked commerce keywords and transmitting the extracted advertisement content to the terminal of the first user, a function of ranking the plurality of general keywords based on a result of the application of the weighted value, and a function of extracting an information content corresponding to the plurality of ranked general keywords and transmitting the extracted information content to the terminal of the first user.

The program may include a function of combining and ranking the plurality of commerce keywords and the plurality of general keywords based on a result of the application of the first weighted value and based on a result of the application of the second weighted value, and a function of extracting an advertisement content and an information content corresponding to a result of the combination and the ranking and transmitting the extracted advertisement content and information content to the terminal of the first user.

The program may include a function of inserting a linkback tag to the plurality of web pages and a function of transmitting the plurality of web pages to which the linkback tag is inserted to the terminal of the first user, and the function of collecting the content information may include collecting the content information by using the linkback tag.

Yet another exemplary embodiment of the present invention provides a computer-readable recording medium in which a program for executing a method of providing an Internet content by using an Internet content providing server is recorded, the method including: a function of transmitting a plurality of web pages including different Internet contents to a terminal of a first user; a function of inserting a linkback tag collecting an action of the first user for the plurality of web pages and content information corresponding to the action of the first user; a function of extracting uniform resource locator (URL) information about a first web page based on a copy action of the first user for a content included in the first web page among the plurality of web pages and a paste action of the first user to a second web page among the plurality of web pages, and generating a more-view link; and a function of collecting content information included in the first web page and the second web page based on an action of a second user for the first web page and the second web page.

The program may include: a function of mapping the collected content information to a pre-stored commerce dictionary and tokenizing and storing a plurality of commerce keywords among the collected content information; a function of mapping the collected content information to a pre-stored general dictionary and tokenizing and storing a plurality of general keywords among the collected content information; a function of extracting an advertisement content corresponding to the plurality of commerce keywords and transmitting the extracted advertisement content to a terminal of the second user; and a function of extracting an information content corresponding to the plurality of general keywords and transmitting the extracted information content to the terminal of the second user.

### Advantageous Effects

According to the exemplary embodiment of the present invention, it is possible to provide an advertisement or an article having a high degree of interest of an Internet user, thereby improving Internet usage efficiency.

According to the exemplary embodiment of the present invention, it is possible to enable an advertiser to generate and provide an advertisement having high accessibility for a user by using an interest keyword of an Internet user, thereby improving advertisement efficiency. Further, it is possible to enable a product or service producer to recognize a recent trend through an analysis of an interest keyword of an Internet user and build a marketing strategy by utilizing the recognized recent trend.

### DESCRIPTION OF THE DRAWINGS

FIG. 1 is a diagram illustrating a configuration of an Internet content providing server according to an exemplary embodiment of the present invention.

FIG. 2 is a diagram illustrating an example of an action of drag & drop and copy of a user for contents of a web page.

FIG. 3 is a diagram illustrating an example of an action of sharing of a user for a web page.

FIG. 4 is a diagram illustrating an example of an action of clicking a more-view link of a user for a web page.

FIG. 5 is a diagram illustrating user information stored in a user database according to an exemplary embodiment of the present invention.

FIG. 6 is a diagram illustrating an Internet content providing method using the Internet content providing server of FIG. 1.

FIG. 7 is a diagram illustrating a weighted value applying method according to an exemplary embodiment of the present invention.

### MODE FOR INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification. Further, a detailed description of a widely known technology is omitted.

In the present specification, unless explicitly described to the contrary, the word “comprise” and variations such as “comprises” or “comprising”, will be understood to imply the inclusion of stated elements but not the exclusion of any other elements. In addition, the terms “-unit”, “module”, and the like described in the specification mean units for processing at least one function and operation and can be implemented by hardware components or software components and combinations thereof.

In the present specification, a “web site” is an aggregate of web pages providing digital contents stored in a web server through the Internet, and includes one or more of a portal site, a search site, an electronic commerce site, a download site, and a community site (a blog, a café, and the like).

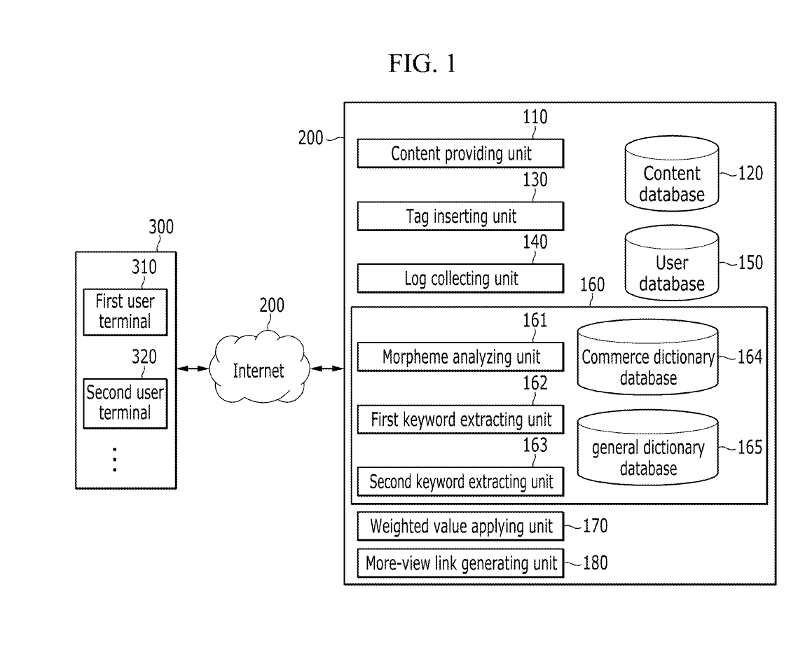

FIG. 1 is a diagram illustrating a configuration of an Internet content providing server according to an exemplary embodiment of the present invention.

An Internet content providing server 100 of FIG. 1 is connected with a user terminal 300 through an Internet network 200. Herein, the Internet content providing server 100 may be constructed by a web server providing digital contents according to the kind of web site, and the user terminal 300 includes a plurality of user terminals 310, 320, . . . using digital contents provided by the Internet content providing server 100. For example, the user terminal 300 may be constructed by one of a cellular phone, a smart phone, a notebook computer, a desktop computer, a table PC, and a personal digital assistant (PDA).

For convenience of the description, FIG. 1 illustrates one Internet content providing server, but a plurality of web servers corresponding to a plurality of web sites may be connected with a user terminal through an Internet network.

The Internet content providing server 100 of FIG. 1 includes a content providing unit 110, a content database 120, a tag inserting unit 130, a log collecting unit 140, a user database 150, a keyword extracting unit 160, a weighted value applying unit 170, and a more-view link generating unit 180. The content providing unit 110 transmits a web page including contents corresponding to a request of the user terminal 300 accessing a web site to the user terminal 300.

The content database 120 stores contents provided through the web site. Herein, the contents include an advertisement, news articles, multimedia, a video, an image, a web document, a hypertext, and the like.

The tag inserting unit 130 inserts a tag (hereinafter, referred to as a “linkback tag”) that tracks an action of a user to the web page provided through the content providing unit 110.

The log collecting unit 140 collects the action of the user accessing the web page, and cookie information and content information corresponding to the action of the user by using the linkback tag, and stores the collected action of the user, cookie information, and content information in the user database 150. Herein, the action of the user includes one or more of drag & drop, copy button click, share button click, more-view link (a movement path to another web page) click, inflow through URL sharing, view frequency, and view time performed for the content of the web page via an input means of the user terminal 300. The cookie information includes an address of a web page which a user accesses, IP information, location information, an operating system (OS), an access device information, and a timestamp. The content information includes one or more of a content, a title, an image, a category, a distribution path (URL and a business operator name) of a web page corresponding to an action of a user, a product name, a product number, a product image, a product price, share, and referral.

The log collecting unit 140 according to the exemplary embodiment of the present invention may collect cookie information and content information in the unit of one minute. Further, the log collecting unit 140 may extract only desired content information by applying a filter and store the extracted content information in the user database 150, thereby decreasing a capacity of the user database 150 and efficiently managing the user database 150. Particularly, it is possible to filter a very short content or a user content that is not normally operated.

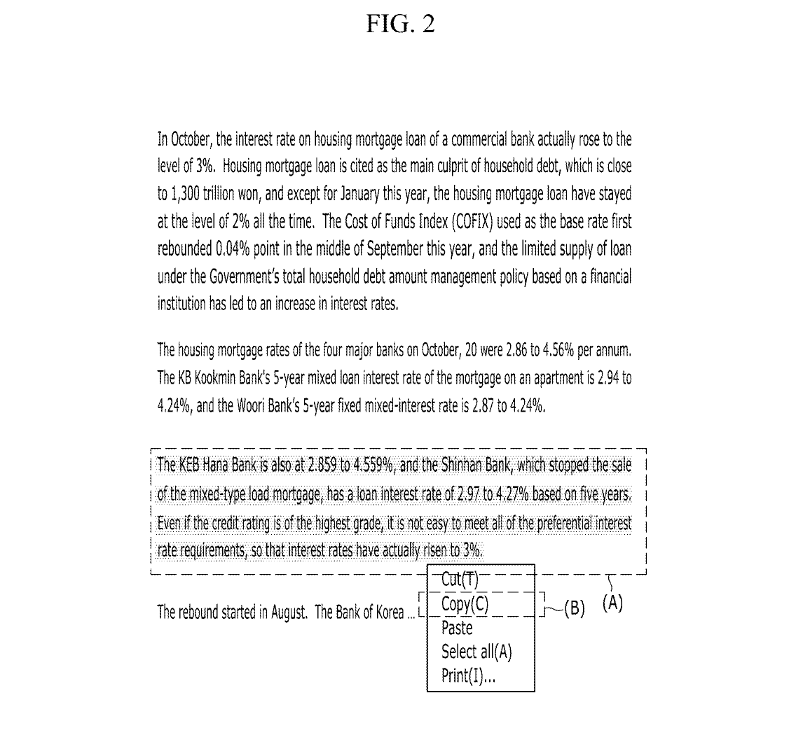

FIGS. 2 to 4 are diagrams illustrating actions of a user according to the exemplary embodiment of the present invention.

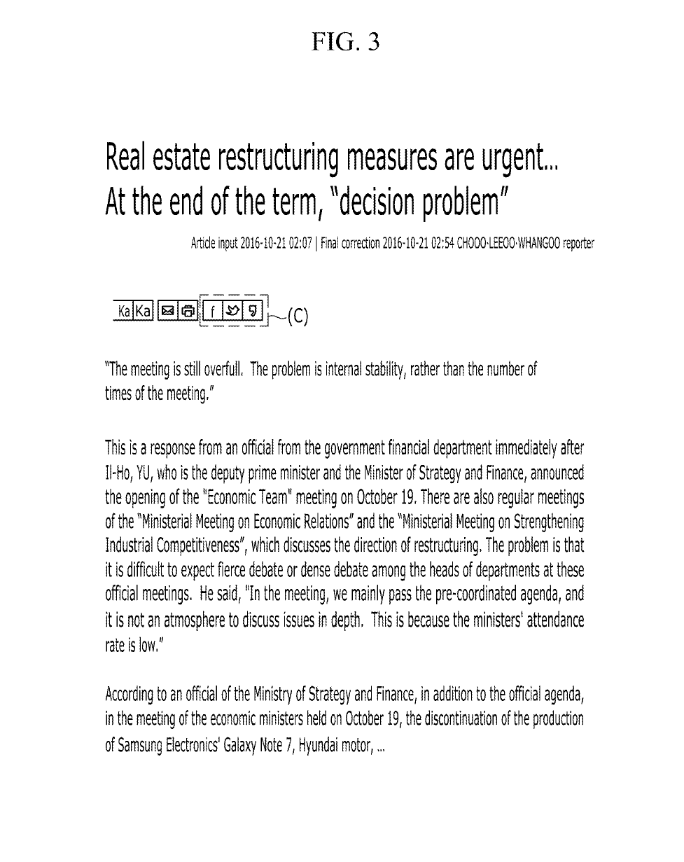

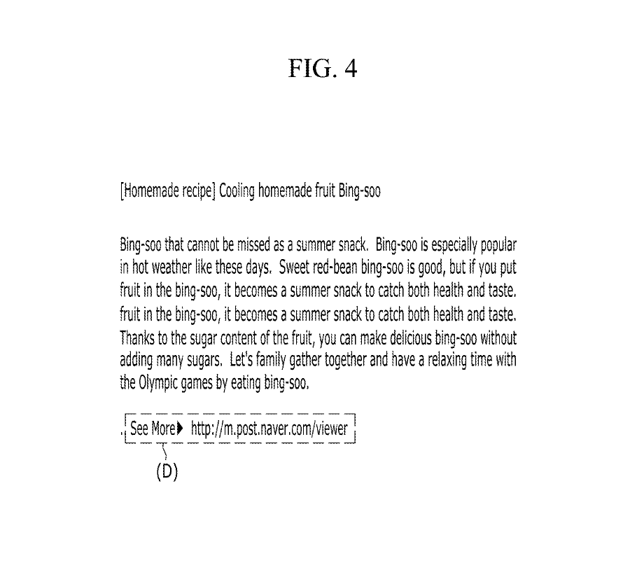

FIG. 2 illustrates an action of drag & drop and copy of a user for contents of a web page, FIG. 3 illustrates an action of sharing of a user for a web page, and FIG. 4 illustrates an action of clicking a more-view link of a user for a web page.

Referring to FIG. 2, when a first user drags and drops A and copies B partial contents of a web page through a first user terminal 310, the log collecting unit 140 collects cookie information and content information about the first user by using a linkback tag and stores the collected cookie information and content information in the user database 150.

Referring to FIG. 3, when the first user selects a share button C of a web page through the first user terminal 310, the log collecting unit 140 collects cookie information and content information about the first user by using a linkback tag and stores the collected cookie information and content information in the user database 150.

Referring to FIG. 4, when the first user selects a more-view link D of a content that is shared by a second user through the first user terminal 310, the log collecting unit 140 collects cookie information and content information about the first user by using a linkback tag and stores the collected cookie information and content information in the user database 150. In this case, when the second user registers a web page desired to be shared or a partial content of the web page as a notice of one or more of a messenger, an Internet café, a blog, and an e-mail through a share button or a copy & paste icon, the more-view link D is automatically inserted together with the partial content of the web page desired to be shared by the second user. The first user may move to the web page desired to be shared by the second user by clicking the more-view link D and recognize entire contents. Herein, the more-view link may include a linkback tag, and collect the action, the cookie information, and the content information about the first user through the linkback tag.

Referring back to FIG. 1, the keyword extracting unit 160 analyzes the content information collected through the log collecting unit 140, structuralizes an analysis result together with the cookie information collected through the log collecting unit 140, and stores the structuralized analysis result and cookie information in the user database 150.

The keyword extracting unit 160 according to the exemplary embodiment of the present invention tokenizes a commerce keyword and a general keyword among the collected content information, and includes a morpheme analyzing unit 161, a first keyword extracting unit 162, a second keyword extracting unit 163, a commerce dictionary database 164, and a general dictionary database 165.

Particularly, the keyword extracting unit 160 extracts a commerce keyword and a general keyword by extracting a language-based root and designating a part of speech, or defines a topic and a concept by analyzing a textual meaning of the collected content. Further, the keyword extracting unit 160 may tokenize a commerce keyword and a general keyword by various methods based on a characteristic (for example, a press, a community, and shopping) of a web page that the user accesses, not based on a grammar of a language.

The morpheme analyzing unit 161 analyzes a morpheme of a sentence included in the title or the content of the web page in the content information stored in the user database 150. The morpheme analyzing unit 161 according to the exemplary embodiment of the present invention may analyze a morpheme for a title or a content of a web page including one or more languages, and separate the sentence included in the title or the contents based on a minimum separable unit.

The first keyword extracting unit 162 maps a morpheme analysis result to a commerce dictionary stored in the commerce dictionary database 164 and tokenizes a commerce keyword.

The second keyword extracting unit 163 maps a morpheme analysis result to a general dictionary stored in the general dictionary database 165 and tokenizes a general keyword. Herein, the general dictionary includes words except for commerce-related words, and includes words, for example, a public office, a tourist site, and a bus station.

The commerce dictionary database 164 stores words related to a tradable product or service. The commerce dictionary database 164 according to the exemplary embodiment of the present invention classifies and stores words according to the degree of importance set based on an advertiser. For example, a finance dictionary may store insurance-related words in a first group, loan-related words in a second group, and pension-related words in a third group.

The general dictionary database 165 classifies and stores words except for the commerce-related words according to a topic. For example, the general dictionary database 165 may store economy, culture, entertainment, politics, life, and weather-related words in a plurality of groups.

According to the exemplary embodiment of the present invention, the keyword extracting unit 160 structuralizes the commerce keyword tokenized by the first keyword extracting unit 162 and the general keyword tokenized by the second keyword extracting unit 163 together with the cookie information of the user collected by the log collecting unit 140 and stores the structuralized commerce keyword and general keyword in the user database 150.

The user database 150 stores the action of the user, the cookie information, the content information collected by the log collecting unit 140 and the commerce keyword and the general keyword tokenized by the keyword extracting unit 160 for each user. Herein, the user database 150 may be constructed by a not only structured query language (NoSQL) database that is a non-relational data storage scheme.

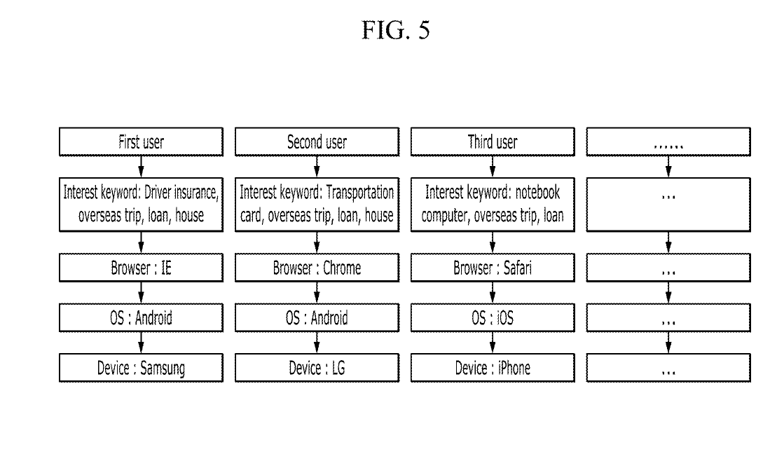

FIG. 5 illustrates user information stored in the user database according to the exemplary embodiment of the present invention.

FIG. 5 illustrates user information stored in the user database 150, and the user information includes an interest keyword, a browser, an OS, and user terminal information for each user. Herein, the interest keyword for each user includes a general keyword and a commerce keyword.

Referring back to the description of FIG. 1, the weighted value applying unit 170 applies a weighted value to the tokenized commerce keyword by the first keyword extracting unit 162 and the tokenized general keyword by the second keyword extracting unit 163, and calculates a commercial keyword index, a general keyword index, and a combined keyword index for each user. The weighted value applying unit 170 according to the exemplary embodiment of the present invention applies a weighted value to the commerce keyword and the general keyword in consideration of an action of the user for a web page corresponding to each of the commerce keyword and the general keyword. In this case, it is assumed that the weighted value corresponding to the action of the user is pre-stored, and the weighted value applying unit 170 may differently apply a weighted value for an action of the user according to a keyword characteristic. For example, the weighted value for each action of the user for the commerce keyword may be applied as represented in Table 1 below, and the weighted value for each action of the user for the general keyword may be applied as represented in Table 2 below.

TABLE 1

| Action of user | Commerce keyword weighted value |
|---|---|
| Drag & drop | 1 |
| Copy button click | 10 |
| Share button click | 3 |
| More-view link click | 8 |
| Inflow through URL share | 8 |
| View frequency | 3 |
| View time | 3 |

TABLE 2

| Action of user | Commerce keyword weighted value |
|---|---|
| Drag & drop | 5 |
| Copy button click | 10 |
| Share button click | 5 |
| More-view link click | 3 |
| Inflow through URL share | 3 |
| View frequency | 8 |
| View time | 8 |

As seen in Tables 1 and 2, for the commerce keyword, a high weighted value may be applied to the action, such as inflow and click, of the user representing the degree of interest, and for the general keyword, a high weighted value may be applied to the action, such as view time, view frequency, copy, and share, of the user representing the degree of concentration.

The weighted value applying unit 170 according to the exemplary embodiment of the present invention applies a weighted value based on a group including a corresponding commerce keyword and a weighted value based on a section including the corresponding commerce keyword to the if) commerce keyword, and applies a weighted value based on a group including a corresponding general keyword and a weighted value based on a section including the corresponding general keyword to the general keyword. Herein, the weighted value based on the group means a weighted value preset for each group stored in each of the commerce dictionary database 164 and the general dictionary database 165, and the weighted value based on the section means a weighted value preset for each section including the number of times of exposure of each of the commerce keyword and the general keyword.

The weighted value applying unit 170 according to the exemplary embodiment of the present invention calculates a commerce keyword index and a general keyword index for each user based on a result obtained by applying the weighted value based on the group, the weighted value based on the section, and the weighted value based on the action of the user. For example, when the weighted value based on the group, the weighted value based on the section, and the weighted value based on the action of the user corresponding to the commerce keyword are assumed as represented in Table 3 below, the commerce keyword index of the user is “(C1×F1×A1)+(C1×F2×A1)+ . . . +(Cn×Fn×A6)” that is a sum of one or more commerce keyword indexes to which the weighted value is applied.

TABLE 3

| Weighted value C | Weighted value F | Weighted value A based |
|---|---|---|
| based on group | based on section | on action of user |
| First group: C1 | First section: F1 | Click more-view link: A1 |
| Second group: C2 | Second section: F2 | Click copy: A2 |
| Third group: C3 | third section: F3 | Click sharing: A3 |
| . . . | . . . | Drag & drop: A4 |
| n − 1^{th} group: Cn − 1 | n − 1^{th} section: Fn − 1 | Share URL: A5 |
| n^{th} group: Cn | n^{th} section: Fn | View time: A6 |

Further, when it is assumed that the weighted values based on a group, a section, and an action of the user corresponding to a general keyword are represented as Table 4 below, a general keyword index of a user is “(B1×F1×A′1)+(B1×F2×A′1)+ . . . +(Bn×Fn×A′6)” that is a sum of one or more keyword indexes to which the weighted value is applied.

TABLE 4

| Weighted value B | Weighted value F | Weighted value A′ based |
|---|---|---|
| based on group | based on section | on action of user |
| First group: B1 | First section: F1 | More-view link click: |
| | | A′1 |
| Second group: B2 | Second section: F2 | Copy click A′2 |
| Third group: B3 | Third section: F3 | Share click: A′3 |
| . . . | . . . | Drag & drop: A′4 |
| n − 1^{th} group: Bn − 1 | n − 1^{th} section: Fn − 1 | URL share: A′5 |
| n^{th} group: Bn | n^{th} section: Fn | View time: A′6 |

The weighted values based on the section of Tables 3 and 4 are defined according to the number of times of the exposure of the keyword, and for example, when the number of times of the exposure is 100 times or more, the weighted value of the first section may be applied, when the number of times of the exposure is 70 times or more, the weighted value of the second section may be applied, and when the number of times of the exposure is 50 times or more, the weighted value of the third section may be applied.

The weighted value applying unit 170 according to the exemplary embodiment of the present invention calculates a combined keyword index by using the commerce keyword index and the general keyword index based on the user. Particularly, the combined keyword index is “(commerce keyword index×R (%))+(general keyword index×(100−R) (%)), and R is an optimization variable.

The content providing unit 110 transmits a content to the user terminal 300 based on the weighted value applying result of the weighted value applying unit 170. Particularly, the content providing unit 110 ranks the commerce keyword and the general keyword according to the weighted value applying result, and transmits an advertisement content corresponding to the commerce keyword and an information content corresponding to the general keyword to the user terminal 300 according to the ranking result. In this case, the ranking includes ranking of the commerce keyword, ranking of the general keyword, and combined ranking of the commerce keyword and the general keyword.

When the first user copies a content included in a first web page and pastes the copied content to a second web page, the more-view link generating unit 180 extracts URL information about the first web page and generates a more-view link. The more-view link is included in the copied contents, and when a second user accessing the second web page selects the more-view link, the second user moves to the first web page including the entire text of the copied content.

The content providing unit 110 according to the exemplary embodiment of the present invention transmits an advertisement content and an information content based on the commerce keyword index, the general keyword index, and the combined keyword index based on the user. For example, the content providing unit 110 may selectively transmit an advertisement content or an information content, control a transmission ratio of an advertisement content and an information content, or confirm reactivity of user A for the Internet content through a comparison and an analysis of a commerce keyword index, a general keyword index, and a combined keyword index of user A. Further, when the combined keyword index is a predetermined value (statistically meaningful value) or more, the content providing unit 110 performs a statistic hypothesis verification based on a click through rate (CTR, reaction ratio of click to content exposure) of the advertisement content and the information content, and when the meaningful change of the CTR is confirmed, the content providing unit 110 continuously corrects the optimization variable R through machine learning, thereby improving accuracy of the combined keyword index of the user.

The Internet content providing server of FIG. 1 may provide an advertiser with the commerce keyword ranking information of the user stored in the user database, the cookie information about the user corresponding to the commerce keyword, and the like, and the advertiser produces and distributes an advertisement by utilizing the commerce keyword-related information based on the user provided from the Internet content providing server, thereby improving advertisement efficiency.

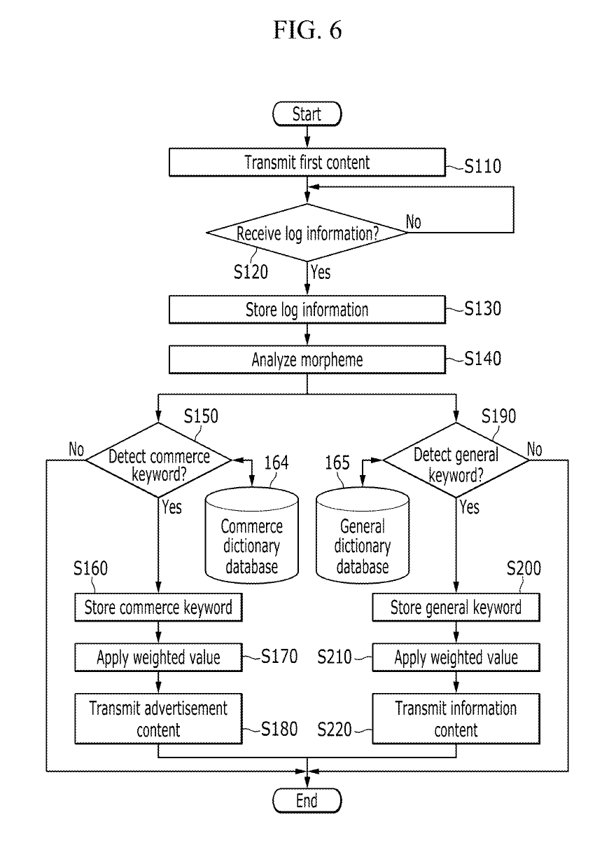

FIG. 6 illustrates an Internet content providing method using the Internet content providing server of FIG. 1.

First, a web page including a first content corresponding to a request of the first user terminal 310 is transmitted via the content providing unit 110 (S110). In this case, the web page transmitted in operation S110 includes a linkback tag inserted via the tag inserting unit 130.

When log information including an action, cookie information, and content information about the user accessing the web page is received via the first user terminal 310 (S120), the log information is stored in the user database 150 (S130).

Then, a morpheme of the content information stored in operation S130 is analyzed via the morpheme analyzing unit 161 (S140). In this case, the content information includes one or more of a content, a title, a category, a distribution path (URL and a business operator name) of a web page, a product name, a product number, a product price, share, and referral.

Then, a result of the morpheme analysis of operation S140 is mapped to a word stored in the commerce dictionary database 164 and a commerce keyword is tokenized and is stored via the first keyword extracting unit 162 (S150 and S160). In operation S160, the commerce keyword and cookie information of the first user received in operation S120 may be structuralized and stored in the user database 150.

For example, in operation S140, a title of the web page of FIG. 3 is separated into “real estate-structure-structuring-measure-urgent-term-end-decision-problem”, and the term “real estate” among the separated terms may be stored as the commerce keyword corresponding to the first user.

Further, the result of the morpheme analysis of operation S140 is mapped to a word stored in the general dictionary database 165 and a general keyword is tokenized and is stored via the second keyword extracting unit 163 (S190 and S200). In operation S200, the general keyword and cookie information of the first user received in operation S120 may be structuralized and stored in the user database 150.

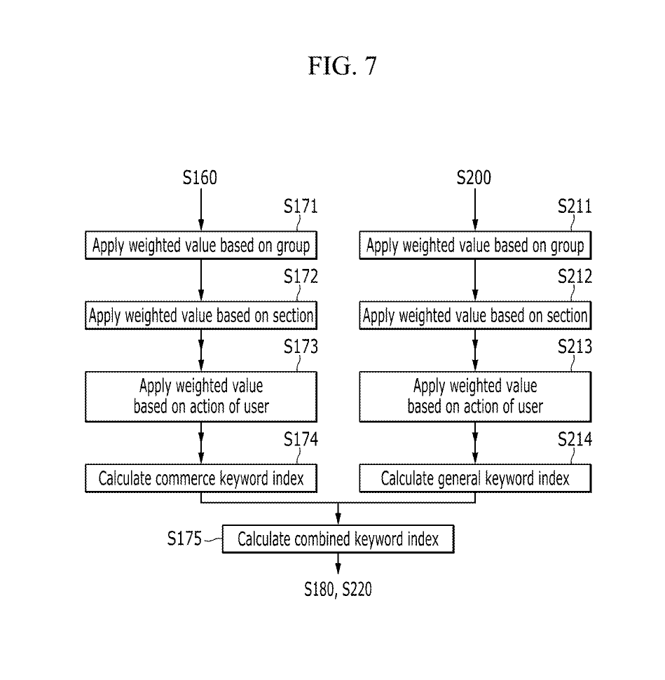

Then, a weighted value is applied to the commerce keyword stored in operation S160 (S170) and applies a weighted value to the general keyword stored in operation S200 via the weighted value applying unit 170 (S210). The weighted value applying method will be described in detail below with reference to FIG. 7.

FIG. 7 is a diagram illustrating a weighted value applying method according to an exemplary embodiment of the present invention.

Referring to FIG. 7, a weighted value based on a group including the corresponding commerce keyword is applied to the commerce keyword stored in operation S160 (S171), a weighted value based on a section including the corresponding commerce keyword is applied to the commerce keyword stored in operation S160 (S172), and a weighted value based on an action of the first user corresponding to the corresponding commerce keyword is applied to the commerce keyword stored in operation S160 (S173). Then, a commerce keyword index of the first user is calculated by using the results of the weighted value application of operations S171 to S173 (S174).

Further, a weighted value based on a group including the corresponding general keyword is applied to the general keyword stored in operation S200 (S211), a weighted value based on a section including the corresponding general keyword is applied to the general keyword stored in operation S200 (S212), and a weighted value based on an action of the first user corresponding to the corresponding general keyword is applied to the general keyword stored in operation S200 (S213). Then, a general keyword index of the first user is calculated by using the results of the weighted value application of operations S211 to S213 (S214).

Then, a combined keyword index of the first user is calculated by using the commerce keyword index calculated in operation S174 and the general keyword index calculated in operation S214 (S175). The combined keyword index calculated in operation S175 is updated when new log information about the first user is collected.

Referring back to the description of FIG. 6, the commerce keyword of the first user is ranked according to the result of the weighted value application of operation S170, and an advertisement content corresponding to the ranked commerce keyword is extracted from the content database 120 and is transmitted to the first user terminal 310 via the content providing unit 110 (S180).

Further, the general keyword of the first user is ranked according to the result of the weighted value application of operation S210, and an information content corresponding to the ranked general keyword is extracted from the content database 120 and is transmitted to the first user terminal 310 via the content providing unit 110 (S220).

Further, the advertisement content or the information content is selectively transmitted, or a transmission ratio of the advertisement content and the information content may be controlled based on the commerce keyword index calculated in operation S174 and the general keyword index calculated in operation S214 via the content providing unit 110.

According to the exemplary embodiment of the present invention, it is possible to collect an interest keyword of a user by analyzing a content of contents provided through a web page and an action of a user for the content. Further, it is possible to provide a customized advertisement content and provide an information content required by a user in consideration of an interest keyword of the user. Accordingly, it is possible to prevent the unnecessary advertisement content and information content from being transmitted to the user and provide the users with the contents in consideration of a keyword rank, thereby improving content usage efficiency and maximizing an effect of a user inflow to the contents.

According to the exemplary embodiment of the present invention, it is possible to make a commerce keyword and a general keyword into indexes by applying different weighted values to the commerce keyword and the general keyword having different consumption perspectives in consideration of the fact that a content consuming purpose is reflected to an action of a user consuming the Internet contents, thereby providing the optimized Internet contents appropriate to a content consuming pattern of the user.

According to the exemplary embodiment of the present invention, it is possible to confirm the degree of reaction to the Internet contents of the user according to a medium characteristic, a social issue, and a seasonal change by using a combined keyword index, and transmit an advertisement content and an information content in a balance way according to the degree of reaction to the Internet contents of the user, thereby maximizing advertisement efficiency and information transmission efficiency.

The Internet content providing method according to the exemplary embodiment of the present invention may be implemented as a program basically installed in a device or directly installed by a user and recorded in a computer-readable recording medium. Herein, a computer may include a desktop computer, a notebook computer, a smart phone, a tablet PC, a PDA, a mobile communication device, and the like. Further, the recording medium may include a read only memory (ROM), a random access memory (RAM), a compact disk (CD)-ROM, a magnetic tape, a floppy disk, an optical media storage device, and the like.

Accordingly, the program including the implemented Internet content providing method according to the exemplary embodiment of the present invention may execute a content information function, a commerce keyword tokenization function, a general keyword tokenization function, a first-weighted value applying function, a second-weighted value applying function, an advertisement content transmission function, an information content transmission function, and the like.

Further, the program including the implemented Internet content providing method according to the exemplary embodiment of the present invention may execute a web page transmission function, a linkback tag insertion function, a more-view link generation function, a content information collection function, and the like.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A server for providing an Internet content, the server comprising:
a log collecting unit which collects content information included in a plurality of web pages based on an action of a first user for the plurality of web pages;
a first keyword extracting unit which maps the collected content information to a pre-stored commerce dictionary and tokenizes and stores a plurality of commerce keywords among the collected content information;
a second keyword extracting unit which maps the collected content information to a pre-stored general dictionary and tokenizes and stores a plurality of general keywords among the collected content information;
a weighted value applying unit which applies a first weighted value to a first commerce keyword among the plurality of commerce keywords and applies a second weighted value to a first general keyword among the plurality of general keywords; and
a content providing unit which extracts an advertisement content corresponding to the first commerce keyword to which the first weighted value is applied and transmits the extracted advertisement content to a terminal of the first user, and extracts an information content corresponding to the first general keyword to which the second weighted value is applied and transmits the extracted information content to the terminal of the first user.

2. The server of claim 1, wherein:
the weighted value applying unit applies the first weighted value for the action of the first user corresponding to the first commerce keyword and applies the second weighted value for the action of the first user corresponding to the first general keyword.

3. The server of claim 1, wherein:
the first weighted value includes a weighted value of a group including the first commerce keyword in the commerce dictionary, a weighted value for the number of times of exposure of the first commerce keyword, and a weighted value for the action of the first user corresponding to the first commerce keyword, and
the second weighted value includes a weighted value of a group including the first general keyword in the general dictionary, a weighted value for the number of times of exposure of the first general keyword, and a weighted value for the action of the first user corresponding to the first general keyword.

4. The server of claim 1, wherein:
the weighted value applying unit ranks the plurality of commerce keywords and the plurality of general keywords according to a result of the application of the weighted value, and
the content providing unit extracts an advertisement content corresponding to the plurality of ranked commerce keywords and transmits the extracted advertisement content to the terminal of the first user, and extracts an information content corresponding to the plurality of ranked general keywords and transmits the extracted information content to the terminal of the first user.

5. The server of claim 1, wherein:
the weighted value applying unit combines and ranks the plurality of commerce keywords and the plurality of general keywords according to a result of the application of the weighted value, and
the content providing unit extracts an advertisement content and the information content corresponding to a result of the ranking and transmits the extracted advertisement content and information content to the terminal of the first user.

6. The server of claim 1, further comprising:
a tag inserting unit which inserts a linkback tag collecting the action of the first user for the plurality of web pages and content information corresponding to the action of the first user; and
a content providing unit which transmits the plurality of web pages into which the linkback tag is inserted to the terminal of the first user.

7. The server of claim 1, further comprising:
a more-view link generating unit which extracts uniform resource locator (URL) information about a first web page based on a copy action of the first user for a content included in the first web page among the plurality of web pages and a paste action of the first user to a second web page among the plurality of web pages, and generates a more-view link.

8. A server for providing an Internet content, the server comprising:
a content providing unit which transmits a plurality of web pages including different Internet contents to a terminal of a first user;
a tag inserting unit which inserts a linkback tag collecting an action of the first user for the plurality of web pages and content information corresponding to the action of the first user;
a more-view link generating unit which extracts uniform resource locator (URL) information about a first web page based on a copy action of the first user for a content included in the first web page among the plurality of web pages and a paste action of the first user to a second web page among the plurality of web pages, and generates a more-view link; and
a log collecting unit which collects content information included in the first web page and the second web page based on an action of a second user for the first web page and the second web page.

9. The server of claim 8, further comprising:
a first keyword extracting unit which maps the collected content information to a pre-stored commerce dictionary and tokenizes and stores a plurality of commerce keywords among the collected content information; and
a second keyword extracting unit which maps the collected content information to a pre-stored general dictionary and tokenizes and stores a plurality of general keywords among the collected content information, and
the content providing unit extracts an advertisement content corresponding to the plurality of commerce keywords and transmits the extracted advertisement content to the terminal of the second user, and extracts an information content corresponding to the plurality of general keywords and transmits the extracted information content to the terminal of the second user.

10. A computer-readable recording medium in which a program for executing a method of providing an Internet content by using an Internet content providing server is recorded, the program comprising:
a function of collecting content information included in a plurality of web pages based on an action of a first user for the plurality of web pages;
a function of mapping the collected content information to a pre-stored commerce dictionary and tokenizing and storing a plurality of commerce keywords among the collected content information;
a function of mapping the collected content information to a pre-stored general dictionary and tokenizing and storing a plurality of general keywords among the collected content information;
a function of applying a first weighted value to a first commerce keyword among the plurality of commerce keywords;
a function of applying a second weighted value to a first general keyword among the plurality of general keywords;
a function of extracting an advertisement content corresponding to the first commerce keyword to which the first weighted value is applied and transmitting the extracted advertisement content to the terminal of the first user; and
a function of extracting an information content corresponding to the first general keyword to which the second weighted value is applied and transmitting the extracted information content to the terminal of the first user.

11. The computer-readable recording medium of claim 10, wherein:
the function of applying the first weighted value includes applying a weighted value for the action of the first user corresponding to the first commerce keyword, and
the function of applying the second weighted value includes applying a weighted value for the action of the first user corresponding to the first general keyword.

12. The computer-readable recording medium of claim 10, wherein:
the function of applying the first weighted value includes applying a weighted value of a group including the first commerce keyword in the commerce dictionary, a weighted value for the number of times of exposure of the first commerce keyword, and a weighted value for the action of the first user corresponding to the first commerce keyword, and
the function of applying the second weighted value includes applying a weighted value of a group including the first general keyword in the general dictionary, a weighted value for the number of times of exposure of the first general keyword, and a weighted value for the action of the first user corresponding to the first general keyword.

13. The computer-readable recording medium of claim 10, wherein:
the program includes a function of ranking the plurality of commerce keywords based on a result of the application of the weighted value, a function of extracting an advertisement content corresponding to the plurality of ranked commerce keywords and transmitting the extracted advertisement content to the terminal of the first user, a function of ranking the plurality of general keywords based on a result of the application of the weighted value, and a function of extracting an information content corresponding to the plurality of ranked general keywords and transmitting the extracted information content to the terminal of the first user.

14. The computer-readable recording medium of claim 10, wherein:
the program includes a function of combining and ranking the plurality of commerce keywords and the plurality of general keywords based on a result of the application of the first weighted value and based on a result of the application of the second weighted value, and a function of extracting an advertisement content and an information content corresponding to a result of the combination and the ranking and transmitting the extracted advertisement content and information content to the terminal of the first user.

15. The computer-readable recording medium of claim 10, wherein:
the program includes a function of inserting a linkback tag to the plurality of web pages and a function of transmitting the plurality of web pages to which the linkback tag is inserted to the terminal of the first user, and
the function of collecting the content information includes collecting the content information by using the linkback tag.

16. A computer-readable recording medium in which a program for executing a method of providing an Internet content by using an Internet content providing server is recorded, the program comprising:
a function of transmitting a plurality of web pages including different Internet contents to a terminal of a first user;
a function of inserting a linkback tag collecting an action of the first user for the plurality of web pages and content information corresponding to the action of the first user;
a function of extracting uniform resource locator (URL) information about a first web page based on a copy action of the first user for a content included in the first web page among the plurality of web pages and a paste action of the first user to a second web page among the plurality of web pages, and generating a more-view link; and
a function of collecting content information included in the first web page and the second web page based on an action of a second user for the first web page and the second web page.

17. The computer-readable recording medium of claim 16, wherein:
the program includes a function of mapping the collected content information to a pre-stored commerce dictionary and tokenizing and storing a plurality of commerce keywords among the collected content information,
a function of mapping the collected content information to a pre-stored general dictionary and tokenizing and storing a plurality of general keywords among the collected content information,
a function of extracting an advertisement content corresponding to the plurality of commerce keywords and transmitting the extracted advertisement content to a terminal of the second user, and
a function of extracting an information content corresponding to the plurality of general keywords and transmitting the extracted information content to the terminal of the second user.
